(19) United States
(12) Patent Application Publication
(10) Pub. No.: US 2002/0015407 A1
(43) Pub. Date: Feb. 7, 2002

(54) Method for transmitting information by means of data packets and network for transmitting data

(75) Inventors: Chris Huebsch, Chemnitz (DE); Ronald Schmidt, Chemnitz (DE); Rainer Kress, Poering (DE)

Correspondence Address: Gerald T. Shekleton, Esq., Welsh & Katz, Ltd., 22nd Floor, 120 S. Riverside Plaza, Chicago, IL, 60606, US

(73) Assignee: Infineon Technologies, AG

(21) Appl. No.: 09/825,145

(22) Filed: Apr. 3, 2001

(30) Foreign Application Priority Data
Apr. 12, 2000 (DE) 100 18 136.8

(51) Int. Cl. H04L 12/56

(52) U.S. Cl. 370/392; 370/401

(57) ABSTRACT

The invention relates to a method for transmitting information by means of data packets, the data packets being forwarded from a transmitter via routers to a receiver and a header of the data packet containing information for the forwarding of the data packet.

According to the invention, this object is achieved by changing the information in the header during the transportation of the data packet.

The invention also relates to a network by means of which the method can be performed.

### DESCRIPTION

Method for transmitting information by means of data packets and network for transmitting data

The invention relates to a method for transmitting information by means of data packets, the data packets being forwarded from a transmitter via routers to a receiver and a header of the data packet containing information for the forwarding of the data packet.

The invention also relates to a network containing routers for transmitting information in data packets.

Generic methods are used in packet-oriented data networks.

Examples of these data networks are the Internet and user-specific networks, especially Intranetworks.

A known problem is that information must be exchanged between a multiplicity of data-communication-capable devices.

As a solution to this problem, it has been proposed to expand the address space from the IPv4 standard to a IPv6 standard.

A problem which is still open is, however, to forward information as efficiently as possible between the various devices.

These devices, which are frequently controlled by means of a microcontroller, will be called devices according to international usage in the text which follows.

To increase the user friendliness of devices, there are networks within networks or between networks. For the devices to be able to exchange information and commands with one another, they must be identified. A number of devices can be combined to form a group (subnetwork). Subnetworks can be formed both statically during the development (combination of a number of devices to form a larger device) or dynamically during use by the end user. Subnetworks, in turn, can be connected to one another.

A known problem consists in that, when arbitrary subnetworks are connected, care must be taken to ensure that unambiguous identification of the devices is possible in all subnetworks. This must also be done in dynamically changing networks.

This problem has previously been solved by using the Internet standard TCP/IP (e.g. the RFC 1180 standard) and issuing 32-bit IP addresses and forming subnetworks on the basis of these IPs. The IP addresses are issued by a centre pool by pool. Data are transported by a special computer (routers) which forward the data packets to other routers in accordance with certain algorithms. Subnetworks are given their own ID in TCP/IP.

The invention is based on the object of performing an exchange of information between the devices with the least possible expenditure and with accurate identification of the devices.

According to the invention, this object is achieved by changing the information in the header during the transportation of the data packet.

Furthermore, the object is achieved by a generic network being designed in such a manner that it contains at least one means which change the information in the header during the transportation of the data packet.

The invention provides for using a dynamic packet structure.

The method is advantageously performed in such a manner that the header contains information on the entire transport path to be travelled when the packet is sent off and that this information is replaced by information on the originator during the transportation of the data packets.

The method is suitably performed in such a manner that the data information reproducing the destination is replaced step by step by the originator information.

The method is advantageously performed in such a manner that the data packets are changed in the area of interfaces.

The method is suitably performed in such a manner that the data are transmitted in a network which is operated in accordance with an Internet protocol.

This makes it possible to use standard routers.

The originator information and the transmitter information preferably contain in this case an internal address which consists, for example, of a network identifier and a host identifier. Using an internal address has the advantage that no expenditure for registration, as is required, for example, with an Internet address, is necessary.

Preferably, microcontrollers are used. For exchanging data, layer-1 protocols are suitably used. These have maximum transfer units (MTUs), for example 16 bits in the case of a CAN bus. It is particularly suitable to use the smallest possible identifiers. This also reduces the length of the hops list entered in the data packets. Address lengths of, for example, 8 bits are sufficient for unambiguous identification in a physical subnetwork. Any device having more than one interface is a bridge. A bridge establishes the connection into another subnetwork. Subnetworks are identified by the ID of the bridge for which the packet is fed into the subnetwork. Instead of allowing the routing to be done by special computers, the path to be travelled by the packet is entered in the header of the packet and the progress of the transportation is recorded. When it passes through the bridges, the routing information to the destination is replaced step by step by the routing information of the originator.

The fact that no special routers are used is an advantage since this task can be handled much more simply by the bridges. In addition, there is no necessity for unambiguous identification of the subnetworks dispensing with, for example, administrative expenditure and saving costs.

It is particularly suitable to use the following packet structure: [length] [number of hops] [current hop][protocols] [hops] * [data] *:

| | |
|---|---|
| Length: | Total length of the packet in bytes |
| Number of hops | The number of devices to be passed |
| Current hop: | The ID of the device to which the |
| | packet is to be sent next |
| Protocol: | A protocol identification for higher |
| | layers of the stack |
| Hops: | A list of Interface ID - Controller |
| | ID pairs |
| Data: | The data to be transported |

Components of this solution are, on the one hand, that the complete routing information is included in the packets; on the other hand, unambiguous source and destination addresses can be determined for the communication partners without administrative expenditure by the users. This means that there does not need to be a centre which distributes addresses. A new device in a subnetwork can secure its own address and does not need to be assigned one.

Further advantages, peculiarities and suitable further developments of the invention are obtained from the subclaims and the subsequent representation of preferred illustrative embodiments, referring to the drawing, in which:

The drawing shows a network according to the invention.

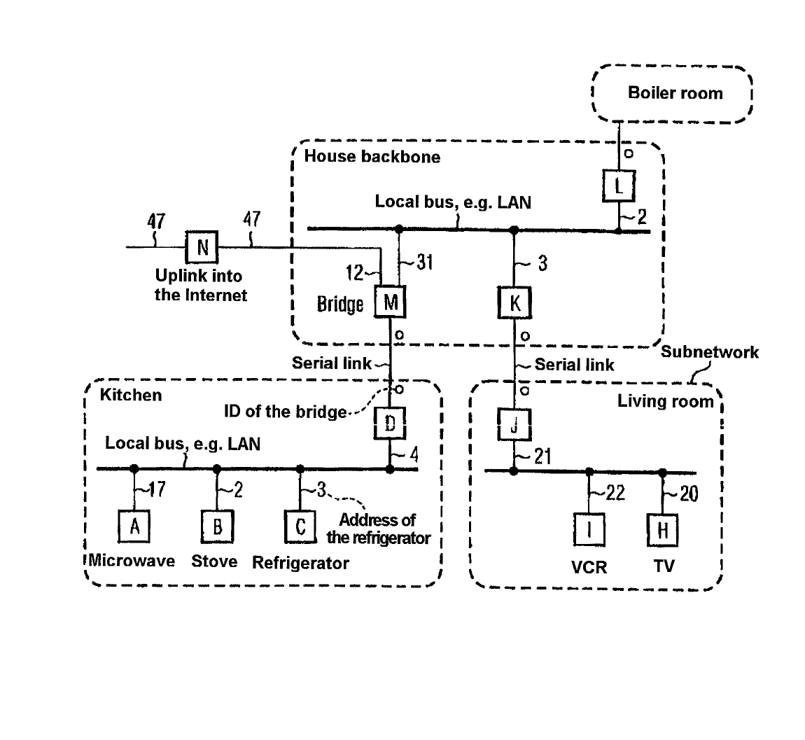

The network shown in FIG. 1 consists of local bus networks (subnetworks) which use, for example, the CAN bus. The subnetworks are connected via direct links, e.g. serial links. The numbers on the bus are unambiguous identifications in the CAN network (they are provided with the interface ID 0 in the example) The numbers of serial lines correspond to identifications on the serial line (in this case Interface ID 1). The capital letters and text are only used for illustration.

### Application 1

A stove (B) interrogates a refrigerator (C) for information (within the subnetwork). The packet initially has the following structure: Length:x No. Hops:2 Current Hop:0 Protocol:x Hops:0 3 data:xxxxx (x designates unimportant information in this case).

The packet is now handed to the general data link layer. This extracts Interface No. 0 as a first step and enters 2 instead of the 0 and increases Current Hop. The packet is then handed to the special data link layer which serves interface 0. The packet now has the following structure: Length:x No. Hops:2 Current Hop:2 Protocol:x Hops:2 0 data:xxxxx

The packet is now handed to the network layer. This layer finds, due to Current Hop equalling No. Hops, that the packet has reached its destination. The route is then reversed in order to normalize it and the packet is handed to the corresponding data link layer. A response would be sent similarly along route: 0 2.

### Application 2

The microwave (A) is to be interrogated for information from the TV (H). The packet would initially have the following structure: Length:x No. Hops:10 Current Hop:0 Protocol:x Hops: 021/1 0/0 31/1 0/0 17 data:xxx

The packet passes through the data link layer and device 21 receives a packet having the following content:

Length:x No. Hops:10 Current Hop:2 Protocol:x Hops:20 0/1 0/0 31/1 0/0 17 data:xxx

This means: device 20 has sent the packet through interface 0 and the next destination is here interface 1, the device 0. The packet has now reached device (J). Since No. Hops is not equal to Current Hop, the packet still needs to be forwarded (bridge function) . Device (K) receives the following packet in its network layer:

Length:x No. Hops:10 Current Hop:4 Protocol:x Hops:20 0/0 0/0 31/1 0/0 17 data:xxx

The packet is now sent to device 31 via interface 0 since it has not yet reached its destination: Length:x No. Hops:10 Current Hop:6 Protocol:x Hops:20 0/0 0/3 0/1 0/0 17 data:xxx

The packet is then sent to device (D) and after that device (A):

Length:x No. Hops:10 Current Hop:8 Protocol:x Hops:20 0/0 0/3 0/31 1/0 17 data:xxx

Length: x No. Hops:10 Current Hop:10 Protocol:x Hops:20 0/0 0/3 0/31 4 0 data:xxx

Since the packet has reached the destination, the route is reversed so that it is possible to identify the originator:

Length:x No. Hops:10 Current Hop:10 Protocol:x Hops: 0 4/1 31/0 2/0 0/0 20 data:xxx

This packet can now be passed into the data link layer. A response would then be sent back in accordance with route 0 4/1 31/0 3/0 0/0 20.

### Application 3

The stove (B) wants to send information to the internet. For this purpose, it is necessary to go into the Internet (N) via the uplink.

The route from (B) to (N) looks as follows: 0 4/1 0/2 47.

The route from (N) to (B): 1 12/1 0/0 2

Looking at the routes it is found that, from the point of view of the “kitchen”, the “backbone” is addressed via [4 1] whereas, from the point of view of the “living room”, the “backbone” is identified by 821 19.

The invention was explained by means of FIG. 1 referring to a network which has subnetworks, the network corresponding to a house and the subnetworks corresponding to individual rooms in the house.

However, the invention is in no way restricted by a size of the networks or, respectively, subnetworks.

Thus, it is possible that the network and/or subnetworks can be much larger or smaller.

Examples of other networks are global data networks such as the Internet or company-wired Intranets. However, the network can also connect components of a complex machine, for example a processing machine, with one another.

Other examples of subnetworks are in-house company networks or components of other networks. In this arrangement, it is possible to arrange the networks and subnetworks in any type of hierarchy. Thus, in the case where the network connects the components of a machine to one another, for example, the subnetwork comprises individual components of this machine, for example a processing arm suitable for performing manipulations.

1. Method for transmitting information by means of data packets, the data packets being forwarded from a transmitter via routers to a receiver and a header of the data packet containing information for the forwarding of the data packet, characterized in that the information in the header is changed during the transportation of the data packet.

2. Method according to claim 1, characterized in that the header contains information on the entire transport path to be travelled when the packet is sent off and that this information is replaced by information on the originator during the transportation of the data packets.

3. Method according to claim 2, characterized in that the data information reproducing the destination is replaced step by step by the originator information.

4. Method according to one or more of the preceding claims, characterized in that the data packets are changed in the area of interfaces.

5. Method according to one or more of the preceding claims, characterized in that the data are transmitted in a network which is operated in accordance with an Internet protocol.

6. Method according to one or more of the preceding claims, characterized in that the data packets contain the following information components: [length] [number of hops] [current hop] [protocol][hops] * [data] *.

7. Network containing routers for transmitting information in data packets, characterized in that it contains at least one means which changes the information in the header during the transportation of the data packet.
